(19) United States
(12) Patent Application Publication
(10) Pub. No.: US 2007/0089465 A1
(43) Pub. Date: Apr. 26, 2007

(54) Carpet having a raschel fabric to the back face

(76) Inventor: Masahiko Imaizumi, Aichi (JP)

Correspondence Address: BRINKS HOFER GILSON & LIONE, P.O. BOX 10395, CHICAGO, IL, 60610, US

(21) Appl. No.: 10/570,841

(22) PCT Filed: Sep. 10, 2004
(86) PCT No.: PCT/JP04/13204

§ 371 Date: Dec. 4, 2006

(30) Foreign Application Priority Data
Sep. 10, 2003 (JP) 2003-31772

(51) Int. Cl. D03D 27/00; B32B 3/02; B32B 33/00; D04B 13/00

(52) U.S. Cl. 66/190; 428/95; 428/92; 428/97

(57) ABSTRACT

A carpet is having a raschel fabric to the back face. The raschel fabric consists of wefts which are inlay-yams and warps which are chain-stitched yarns. The warp consists of chain-stitched ground yarns 3a, 3b, and a pile yarn 4 which forms standing loop piles on specified courses and which is chain-stitched with the ground yarns except said specified courses. The pile yarn consists of two mono-filaments 5, 5. The two mono-filaments 5, 5 are twisted at least one time per the length of each loop pile. Cut piles are formed by mechanically cutting the each loop pile near the top thereof. The two mono-filaments in the cut pile are disjoining each other and standing with inclination at random direction on the raschel fabric. When the carpet is placed on the surface of a mat, each mono-filament which is formed on the back face of the carpet, bites into the surface of the mat. Therefore, it is prevented that the carpet is displaced.

### TECHNICAL FIELD

The present invention relates to various carpet used as a floor carpet for an automobile, a indoor carpet, a hot carpet for an electric heater, a door carpet for removing soil on soles, a kitchen carpet. Especially, the invention relates to a carpet having a raschel fabric to the back face and the function to prevent to displace or slip.

### BACKGROUND ART

A mat is entirely placed on a floor in the automobile or the room. Moreover, a small carpet may be placed on the mat. In the invention, the carpet means the small carpet placed on the mat.

The carpet was easily displaced since the carpet was only piled up on the surface of the mat, although depending on the condition of the surface of the mat. That is, since low was the coefficient of friction between the back face of the carpet and the surface of the mat, the carpet was slipped and displaced on the surface of the mat. Therefore, a raschel fabric specially treated was attached on the back face of the carpet, and it was prevented the carpet to be displaced by giving the function of non-slip. For example, it was carried out to attach the raschel fabric forming plural standing loop piles on the back face of the carpet. In this case, it was prevented the carpet to be displaced by the loop piles which were provided on the back face of the carpet and were bitten into the surface of the mat. However, the loop piles were generally inclined at the direction of the knitting, therefore, biting the loop piles into the surface of the mat, the carpet was easily displaced to the opposite direction of the inclining direction, although the carpet might be not displaced to the inclining direction. Moreover, it was essentially difficult that the loop piles bit into the surface of the mat, since each top of the loop piles had become round.

Therefore, it was carried out to heat and melt each top of the loop piles in the range of ¼ or more in the length. The top was cut by melting and changed to cut piles. The molten ball was formed on the cutting end of the cut pile. Moreover, the molten ball was inclined at random, by pushing the top, when heating and melting the top (patent reference 1). In the case that the cut piles having the molten balls were existed on the back face of the carpet, it was prevented that the carpet was displaced on the mat since the cut piles having the molten ball bit into the surface of the mat. Moreover, it was prevented that the carpet was displaced at all direction, since the cut piles were inclined at random.

Patent reference: JP3-60483B (pages 2, from lines 37 of columns 3 to lines 3 of columns 4. pages 2, from lines 41 to lines 43 of columns 4. a drawing of pages 4)

### DESCRIPTION OF THE INVENTION

### Problem to be Solved by the Invention

However, using the technique described in the patent reference 1, the loop piles had to be pushed by a heated object when heated and molten to incline the cut piles at random. Accordingly, since the heated object drew toward the raschel fabric, there was a danger that the raschel fabric was burned.

The invention avoids to obtain the cut piles which are inclined at random by the technique described in the patent reference 1. By the invention, it is possible to automatically obtain the cut piles which are inclined at random when each top of the loop piles is mechanically cut. Accordingly, the problem to be solved by the invention is to form the cut piles which are stood and inclined at random on the raschel fabric by simple means.

### MEANS FOR SOLVING THE PROBLEM

The invention relates to the carpet to the back face comprises the raschel fabric. The raschel fabric comprises wefts which are made of inlay-yarns, and warps each of which contains at least one chain-stitched ground yarn and at least one pile yarn. The pile yarn forms standing loop piles on specified courses and it is chain-stitched with said ground yarn except said specified courses. The pile yarn comprises at least two mono-filaments which are twisted at least one time per the length of each loop pile. The each loop pile is mechanically cut near the top thereof, and is changed into cut piles. Each of the cut piles comprises the mono-filaments which are disjoining each other and standing with inclination at random direction on the raschel fabric.

The carpet of the invention may be laminated and unified in order of the raschel fabric 1 and the body 11 of the carpet from the surface. Moreover, the carpet of the invention may be laminated and unified in order of the raschel fabric 1, a layer of foamed material 12 and the body 11 of the carpet from the surface (FIG. 1). As the body 11 of the carpet, a conventional material may be used. For example, a woven fabric, a knitted fabric or a nonwoven fabric etc. may be used. The body 11 of the carpet and the raschel fabric 1 may be laminated and unified by an optional meanings. For example, they may be laminated and unified by an adhesive agent. Furthermore, in the case that the body 11 is the nonwoven fabric, they may be laminated and unified by interlacing fibers in the nonwoven fabric to the wefts and/or warps in the raschel fabric 1 with a needle punching machine. In the case, as the fibers in the nonwoven fabric, fibers having low melting point may be entirely or partially used, or sheath-core type conjugate fibers each of which has the sheath component of low melting point component and the core component of high melting point component may be entirely or partially used. The fibers having low melting point or the sheath component of the conjugate fibers may be molten and solidified, the fibers and the wefts and/or warps may be melt-bonded. Therefore, the nonwoven fabric of the body 11 and the raschel fabric 1 may be more strongly laminated and unified. Furthermore, in the case of FIG. 1, the body 11 of the carpet and the layer of foamed material 12 may be laminated and unified by the optional meanings which is adherence by the adhesive agent, for example. Especially, if the body 11 is the nonwoven fabric, they may be laminated and unified by interlacing fibers in the nonwoven fabric to the layer of foamed material 12 with the needle punching machine. The rashel fabric 1 exists on the back face of the layer of foamed material 12, and exists as the back face of the carpet.

The rashel fabric 1 is a conventional rashel fabric and consists of wefts which are inlay-yarns and warps which are chain-stitched yarns. The warp 2 consists of a ground yarn 3 and a pile yarn 4. As the ground yarn, a conventional yarn such as a mono-filament, a multi-filament or a spun yarn etc. may be used. It may be preferable to use the mono-filament as the ground yarn because a mono-filament is too used as the pile yarn. A polyethylene mono-filament, a polypropylene mono-filament or polyamide(nylone) mono-filament etc. may be used as a kind of the mono-filament. The fineness of the mono-filament may be 100 deniers or more, preferably about 300 deniers.

FIG. 2 shows only the warps 2 in the rashel fabric, and the wefts of the inlay-yarns are omitted. In the FIG. 2, two yarns of the ground yarn 3a and 3b are used as the ground yarn 3. That is, the warp 2 is formed by left and right symmetrically chain-stitching the two yarns with two guide bars. The directivity of the chain-stitched warp 2 is smaller by left and right symmetrically chain-stitching. It is preferable because it is easy to straightly stand the loop piles which leave to upward from the ground yarn 3a and 3b.

The pile yarn 4 is chain-stitched such as the ground yarn. However, the standing loop piles are formed on specified courses. For example, the pile yarn is chain-stitched through four courses and looped on the next course as showing in FIG. 2. And again, the pile yarn is chain-stitched through four courses and looped on the next course. The pile yarn is again and again knitted by the above mentioned method. Accordingly, one of the standing loop piles are formed per four courses. Each of the warps 4 has the loop piles. It is preferable to have the loop piles at zigzag without having the loop piles at the same course on adjacent warps 2,2 . . . . In the zigzag case, the cut piles from the loop piles may even bite into the surface of the mat.

FIG. 3 is a typical figure which shows the pile yarn 4, the ground yarn 3a and 3b in the warp by separating. As showing in FIG. 3, the warp 2 consists of one pile yarn 4 and two ground yarns 3, that is, of three yarns at total in one embodiment of the invention. However, the warp 2 may consist of at least one pile yarn and at least one ground yarn, for example, of one pile yarn and one ground yarn. Furthermore, the warp may consist of two pile yarns and two ground yarns, that is, of four yarns at total. Furthermore, the warp may consist of five or more yarns at total.

The invention is characterized by that the pile yarn 4 is composed of at least two mono-filaments. As a kind of the mono-filament, a polyethylene mono-filament, a polypropylene mono-filament or polyamide(nylone) mono-filament etc. may be used. The fineness of the mono-filament may be 100 deniers or more, preferably about 300 deniers. And at least two mono-filaments must be twisted and twist times must be more than designated twist times. The designated twist times are more than one time per the length of the loop pile. Because each mono-filament is twisted one or more times per the length of the loop pile, cutting near the top of the loop pile, the twisting is loosened and the cut ends are turned at random direction. Accordingly, the cut piles stand on inclination and at random direction. The rigidity of each mono-filament 5,5 . . . contributes to loosen the twisting. Therefore, it is preferable that the fineness of each mono-filament 5,5 . . . is thicker, that is, 100 deniers or more such as above mentioned.

As the inlay-yarn which is the weft of the raschel fabric, a conventional yarn may be used. It is preferable to use a spun yarn as the inlay-yam. This reason is that the portion of the back face of the foamed material 12 comes in among the fibers composing the spun yarn, in the case that the raschel fabric 1 is laminated and unified to the foamed material 12 at producing as FIG. 1. Furthermore, in the case that the raschel fabric 1 is laminated and unified to the nonwoven fabric used as the body 11 of the carpet with the needle punching machine, the fibers composing the spun yarn may be preferably interlaced with the fibers in the nonwoven fabric.

The carpet of the invention may be produced by the following method. For example, the body 11 of the carpet may be adhered to the surface of the raschel fabric with adhesive agent etc. The surface of the raschel fabric is the surface on which the loop piles are not formed. As the result, the laminating material which the raschel fabric 1 is laminated and unified to the body 11 of the carpet, is obtained. In the case that the body 11 of the carpet is the nonwoven fabric, the body 11 is laminated to the raschel fabric 1, and is treated with the needle punching machine. By needle punching, the fibers in the nonwoven fabric are interlaced with the wefts and/or the warps. As the result, the laminating material which the raschel fabric 1 is laminated and unified to the body 11, is obtained. Furthermore, a foamable resin is laminated to the surface of the raschel fabric on which the loop piles are not formed, and the body 11 is laminated to the surface of the foamable resin. After that, the foamable resin is foamed and the foamed material 12 is obtained. And when foaming, because the foamable resin is adhesive, the body 111 of the carpet, the layer of the foamed material 12 and the raschel fabric 1 are laminated and unified. As the result, the laminated material is obtained. Moreover, the foamed material 12 is laminated and unified to the body 11 of the carpet with the adhesive agent or the needle punching machine, And then, the surface of the foamed material 12 is adhered by the adhesive agent etc. to the surface of the raschel fabric 1 on which the loop piles are not formed. As the result, the body 11 of the carpet, the layer of the foamed material 12 and the raschel fabric 1 are laminated and unified, and the laminated material is obtained. After the laminated material is obtained, each of the loop piles which are forming on the back surface of the raschel fabric is cut near the top thereof with a knife. As the result, the carpet of the invention may be obtained. On the other side, when the raschel fabric is knitted, each loop pile is cut near the top simultaneously or after forming the loop pile. Then the raschel fabric having the cut piles may be obtained as shown by FIG. 4. The carpet of the invention may be obtained by laminating and unifying the body 11 of the carpet to the surface of the raschel fabric on which the cut piles are not formed. Moreover, the foamable material is laminated to the surface of the raschel fabric on which the cut piles are not formed, and the body 11 of the carpet is laminated to the surface of the foamable material, after that, the foamed material may be obtained by foaming the foamable material, as the result, the carpet of the invention may be obtained. Furthermore, two layer material consisting of the layer of the foamed material 12 and the body 11 of the carpet which are laminated and unified, is adhered by the adhesive agent to the surface of the raschel fabric on which the cut piles are not formed. As the result, the body 11 of the carpet, the layer of the foamed material 12 and the raschel fabric 1 (the cut piles have been formed on the back surface of the raschel fabric 1) are laminated and unified, then the carpet of the invention may be obtained. The cutting end of the cut pile may be not treated, or may be treated to produce the molten ball. That is, the molten ball is produced by melting the cutting end with a singeing machine or a heater etc. The molten ball effectively prevents the carpet to be displaced.

The carpet of the invention may be used as the small carpet. The carpet may be placed on the mat which is entirely placed on the floor. However, the carpet of the invention may be placed on the floor without using the mat.

### EFFECT OF THE INVENTION

The invention adopts the specific pile yarn forming the pile loop which exists on the raschel fabric adhered to the back side of the carpet. That is, the pile yarn consists of at least two mono-filament, and is twisted at one or more times per the length of the loop pile. Accordingly, when the loop pile is mechanically cut near the top thereof, the mono-filaments twisted at least one time are disjoining each other and the cutting ends are turned at random direction. Therefore, each of the cut piles having the cutting ends is turned at random direction, and is stood on inclination. That is, by using the invention, the cut piles which are stood on inclination at random direction are obtained with only cutting each of the loop piles. And when the carpet is placed on the mat etc., it is prevented that the carpet is displaced at all direction.

As the above mentioned, the invention easily gives the carpet which is having the function of non-slipping at all direction.

### DESCRIPTION OF DRAWINGS

FIG. 1 is a typical side view of a carpet to back face of which a raschel fabric is adhered.

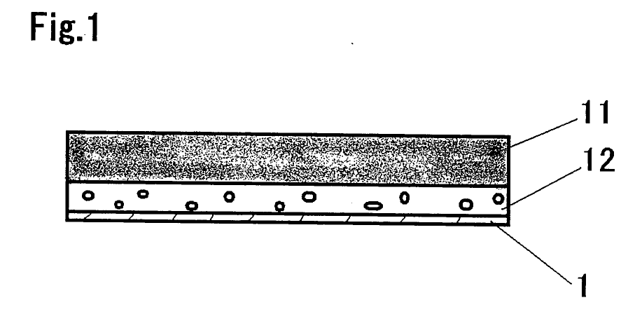

FIG. 2 is a typical view of a knitting design of a raschel fabric.

FIG. 3 is a typical view of each mono-filament composing each warp in the FIG. 2.

FIG. 4 is a typical view of cut piles which is formed by cutting each loop pile on the raschel fabric at near the top in the FIG. 2

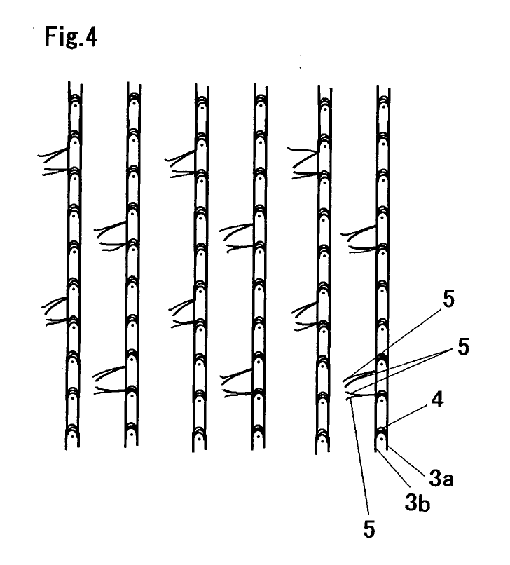

### DESCRIPTION OF NUMERAL OF DRAWINGS

Numeral 1 is a raschel fabric.
Numeral 2 is a warp.
Numeral 3, 3a, 3b are ground yarns.
Numeral 4 is a pile yarn.
Numeral 5 is a mono-filament composing the pile yarn.

### EXAMPLE

### Example 1

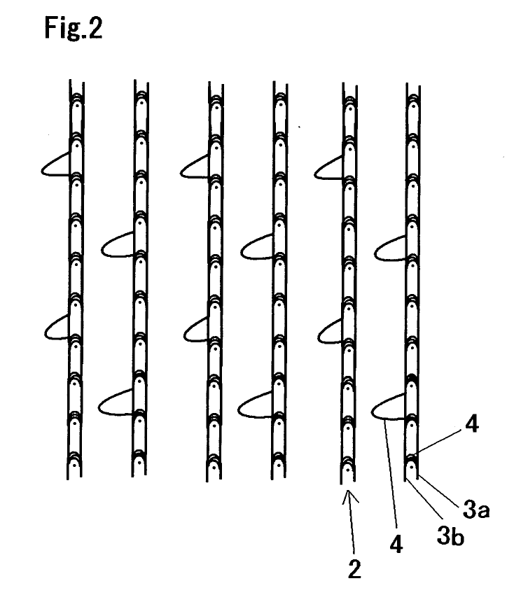

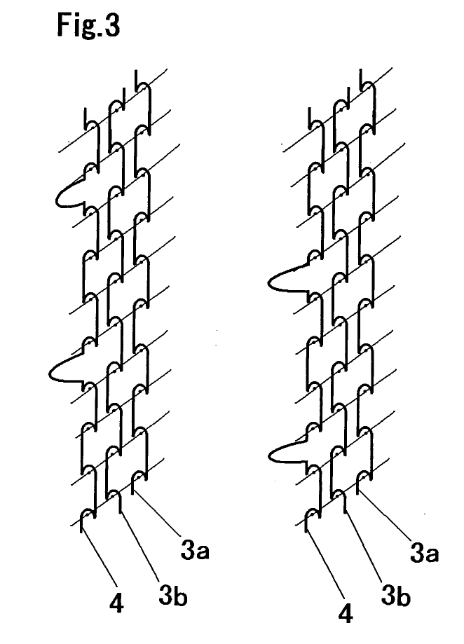

Two polyethylene mono-filaments each of which was 300 deniers of fineness were prepared as a ground yarn. One pile yarn in which two polyethylene mono-filaments were twisted at 180 times per meter was prepared. The polyethylene mono-filament was 300 deniers of fineness. A inlay-yam of a weft which was a spun yarn was prepared. The spun yarn was 3.5 of yarn number count and consisted of a mixture of polyester fibers and acrylic fibers. Using the ground yarns, the pile yarns and the inlay-yam, the raschel fabric consisting of warps and wefts was knitted with the knitting design as shown in FIG. 2 (FIG. 3) and loop piles were formed per 4 course. A count of knitting gauges was 2 gauges per a inch and a count of courses was 10 courses per a inch. The length of the loop pile was 10 mm. The loop piles were provided at zigzag on adjacent warps. After that, each loop pile was cut at near the top thereof with a knife and cut piles were formed. As the result, the cut piles were stood on inclination and at random direction. After that, a cutting end of the cut pile was heated with a heater, a molten ball was formed at the cutting end. As the above mentioned, the raschel fabric having cut piles was obtained.

### Example 2

Two pile yarns in which two polyethylene mono-filaments were twisted at 180 times per meter were prepared. The polyethylene mono-filament was 300 deniers of fineness. Adding one pile yarn in the knitting design as shown in FIG. 2 (FIG. 3), the raschel fabric was obtained by the same method of the example 1.

### Example 3

A inlay-yam which was polypropylene multi-filament of 2400 deniers/192 filaments was prepared. Using the inlay-yam, the raschel fabric was obtained by the same method of the example 1.

### Example 4

Polyurethane resin was applied to the back surface of the body of the carpet. Each raschel fabric of the above Examples was laminated to the layer of the polyurethane resin. The surface of the raschel fabric on which cut piles were not formed was contacted to the layer of the polyurethane resin. After that, the layer of the polyurethane resin was foamed by heating, and three carpets were obtained. Each of three carpets was consisted of that the body of the carpet, the layer of foamed polyurethane resin and each raschel fabric were laminated and unified. When each carpet was placed on the mat, the cut piles on the back surface of the carpet bit in the surface of the mat and it was prevented that the carpet was displaced at all direction.

What is claimed is:

1. A carpet to the back face comprising a raschel fabric which comprises wefts which are made of inlay-yarns, and warps each of which contains at least one chain-stitched ground yarn and at least one pile yarn which forms standing loop piles on specified courses and which is chain-stitched with said ground yarn except said specified courses, wherein:
said pile yarn comprises at least two mono-filaments which are twisted at least one time per the length of each loop pile;
said each loop pile is cut near the top thereof, and is changed into cut piles; and
each of said cut piles comprises said mono-filaments which are disjoining each other and standing with inclination at random direction on said raschel fabric.

2. The carpet according to claim 1 wherein the loop piles are provided in a zigzag form in adjacent warps.

3. The carpet according to claim 1, further comprising two ground yarns each of which consists of two mono-filaments, wherein said two mono-filaments are each symmetrically chain-stitched in left and right with each guide bar.

4. The carpet according to claim 1 wherein the inlay-yarns are spun yarns.

5. A raschel fabric to attach on the back face of a carpet, comprising wefts which are made of inlay-yarns, and warps each of which contains at least one ground yarn and at least one pile yarn which forms standing loop piles on specified courses and which is chain-stitched with said ground yarn except said specified courses, wherein said pile yarn comprises at least two mono-filaments which are twisted at least one time per the length of each loop pile.

6. A raschel fabric to claim 5 wherein each loop pile is cut near the top thereof, and is changed into cut piles; and
each of said cut piles consists of said mono-filaments which are disjoining each other and standing with inclination at random direction on said raschel fabric.
